(19) United States
(12) Patent Application Publication
(10) Pub. No.: US 2005/0083556 A1
(43) Pub. Date: Apr. 21, 2005

(54) Image cropping based on imaged cropping markers

(76) Inventor: Gerard J. Carlson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/690,048

(22) Filed: Oct. 20, 2003

(51) Int. Cl. H04N 1/04; H04N 1/047; H04N 1/10

(52) U.S. Cl. 358/474; 358/453; 358/488

(57) ABSTRACT

A device for capturing cropped images in digital form. The device may include an optical window and an image sensor. The image sensor may be configured to sense optical information received at least substantially through the optical window so that input image data is acquired. The device also may include one or more cropping markers adjustably positionable adjacent the optical window so that the cropping markers are imaged by the image sensor to contribute marker data to the input image data. A controller may be configured to analyze the input image data to create cropped image data from a subset of the input image data according to the marker data.

### BACKGROUND

Digital image capture devices, such as scanners and photocopiers, are configured, generally, to acquire image data from a presented physical object, such as a document or picture. A user may place the object on an optical window (typically, a sheet of glass). A fixed or movable array of optical sensors below the window then may sense reflected (or transmitted) light that travels through the window from the object and, when the object does not fill the window, from a background region adjacent the object. Light passing through positions of the window corresponding to the object and the background region may be sensed and transduced into digital data elements to provide image data describing optical properties of the object and the background region. The image data may be displayed or printed to produce a corresponding optical image of the object and background.

The optical image may include an image portion of interest and an extraneous portion to be removed. For example, the image portion may correspond to the object and the extraneous portion to the background region, such as when scanning a document that is smaller than the window. Alternatively, the image portion may correspond to a region of the object, such as when the object presents two or more pictures or text sections and only one is of interest. In some cases, the image portion may be larger than the object, for example, when a picture or text presented by the object has an insufficient border defined by the object. In other cases, the image portion may correspond to a portion of the object and a portion of the background region, for example, when a picture or text is disposed near an edge of the object and a border around the picture or text is desired.

Cropping may be performed to remove the extraneous portion from an optical image. Cropping may be specified on the optical image by a person so that image data specifying the extraneous portion is removed. For example, the optical image may be created from the image data and displayed on a monitor for selection of a region of interest within the optical image, and thus selection of a corresponding portion of the image data. Nonselected portions of the image data then may be deleted. In another form of cropping, lower resolution image data may be acquired from a larger portion of the window. Then, higher resolution image data may be acquired from a smaller portion of the window that corresponds to a region of an optical image, selected from an image displayed using the lower resolution image data. Each of these approaches to cropping may require a monitor to display the image, adding expense to the image capture device.

### SUMMARY

A device is provided for capturing cropped images in digital form. The device may include an optical window and an image sensor. The image sensor may be configured to sense optical information received at least substantially through the optical window so that input image data is acquired. The device also may include one or more cropping markers adjustably positionable adjacent the optical window so that the cropping markers are imaged by the image sensor to contribute marker data to the input image data. A controller may be configured to analyze the input image data to create cropped image data from a subset of the input image data according to the marker data.

### BRIEF DESCRIPTION OF THE DRAWINGS

FIG. 1 is a view of an image capture system including an imaging device utilizing imaged cropping markers and supporting a sheet of material to be imaged, and a controller coupled with the imaging device, in accordance with an embodiment of the invention.

FIG. 2 is a top plan view of the imaging device of FIG. 1, with the cropping markers selecting a region from which cropped image data is created, in accordance with an embodiment of the invention.

FIG. 3 is a fragmentary sectional view of the imaging device of FIG. 2, viewed generally along line 3-3 of FIG. 2.

FIG. 4 is a schematic view of the image capture system of FIG. 1.

FIG. 5 is a plan view of alternative cropping markers disposed on a side of a sheet of material to be imaged and configured to be imaged by the image capture system of FIG. 1 to select a region from which cropped image data is created, in accordance with an embodiment of the invention.

FIG. 6 is a flowchart of a method of capturing cropped optical images in digital form, in accordance with an embodiment of the invention.

### DETAILED DESCRIPTION

A system, including apparatus and method, are provided for capturing cropped optical images in digital form. The system may include an imaging device having an image sensor that senses optical image information from a field of view. The field of view may correspond substantially to an optical window of the imaging device through which the optical image information may be received. One or more physical cropping markers may be positioned within the field of view so that they are included in the optical image information sensed by the image sensor. The physical cropping markers may define a perimeter within the field of view from which a subset of the optical image information is selected to create cropped image data. Utilization of physical cropping markers to select cropped image data may provide a cheaper and/or simpler alternative to other cropping approaches.

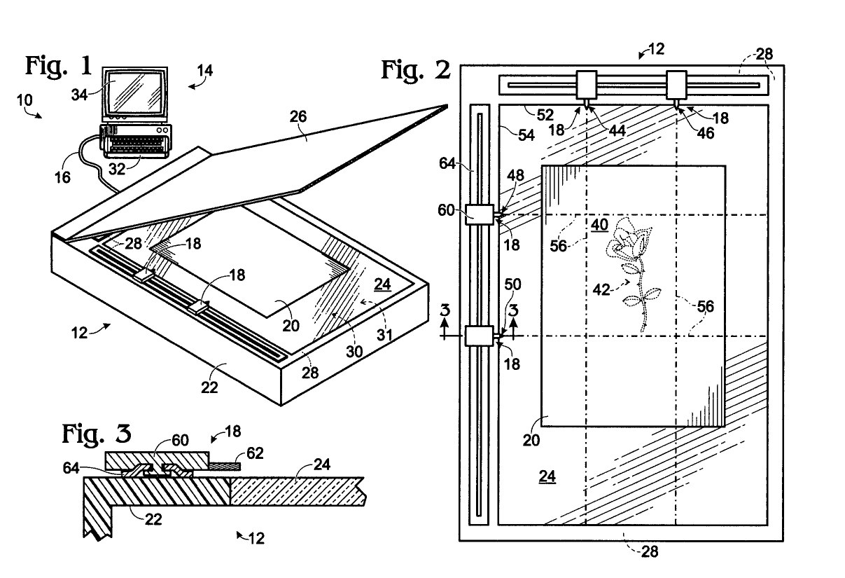

FIG. 1 shows an image capture system 10 utilizing imaged cropping markers to select cropped image data. System 10 may include an imaging device 12 in communication with a controller 14 through a communications link 16. The imaging device may include physical cropping markers 18. The cropping markers may be disposed so that they are imaged as imaging device 12 creates image data from an imaged object 20, such as a sheet of paper bearing text or pictures, among others. Marker data provided by imaging the cropping markers may be used to select a subset of the image data according to the physical positions of cropping markers 18.

Imaging device 12 may be any device configured to create image data corresponding to the light received from an object(s) and regions surrounding the object. Such creation of image data may be referred to as image capture, image acquisition, or imaging. The image data may be utilized by the imaging device or another device (such as a monitor, a printer, a projector, etc.) to produce an optical reproduction or counterpart (an image) of the object, surrounding regions, or a selected portion thereof. The image data may be digital information, and may be electronic, magnetic, optical, and/or the like. Exemplary imaging devices may collect optical information from a substantially two-dimensional or three-dimensional object(s) or surface(s). For example, a substantially two-dimensional or planar object (or surface) may be a sheet of material (such as paper, film, a plastic overlay, etc.). Alternatively, the planar surface may be a flat side of a substantially three-dimensional object. In some embodiments, light may be received from a three-dimensional object or surface. In any case, the light may be focused, for example, using suitable optics, such as lenses. Exemplary imaging devices for planar objects or surfaces may include scanners, photocopiers, and facsimile machines, among others, and may include cameras for three-dimensional objects and surfaces.

Imaging device 12 may include a frame or housing 22, an optical window 24, and a cover 26. Frame 22 may be configured to house electronic, mechanical, and optical components of the imaging device. In addition, frame 22 may be connected to cropping markers 18. Optical window 24 may be connected to, and/or defined by, the frame. The optical window may be any region or aperture configured to permit entry of light into the imaging device. Accordingly, optical window 24 may be formed by a planar sheet of glass or plastic, a lens, or may be defined by air and an aperture in frame 22. Optical window 24 may correspond substantially to a field of view of the imaging device, that is, a region from which the device is configured to collect light. Alternatively, imaging device 12 may be configured to view light from a subset of optical window 24 and/or light from regions 28 lateral to (adjacent) the optical window. Regions 28 may be inside of frame 22. Cover 26 may be configured to restrict ambient light from entering the field of view. The cover may be moved between an apposed and a spaced relation from the optical window.

Imaging device 12 may include an image sensor 30 that senses light received from the field of view, particularly light reflected or transmitted from object 20 apposed to optical window 24. Image sensor 30 may include any mechanism for converting light into corresponding signals, such as electrical signals. The image sensor may be a linear or two-dimensional array of sensor elements, among others. For example, the image sensor may be an array of charge-coupled devices or CMOS devices. Each sensor element may include one or more photodiodes or other photosensitive devices. The light used by the imaging device may be external light or may be substantially generated from an internal light source 31, disposed, for example, inside frame 22 or cover 26.

Controller 14 may be any computing device configured to perform manipulation of data, particularly image data. The controller may be integral to imaging device 12 or may be a separate device, as shown in FIG. 1. Accordingly, communications link 16 may be any suitable conduit or pathway for exchanging electrical signals, optical signals, and/or electromagnetic radiation, among others. The controller may provide a user interface 32, such as a keyboard, mouse, touchpad, or touchscreen, among others, to receive user inputs for operation of imaging device 12 and/or controller 14. The controller also may include a display 34 or printer to create an image from image data.

A cropping marker 18 may be any predefined physical structure(s) that is imaged to contribute distinguishable marker data to the image data. The cropping marker may be configured to be positioned adjustably in the field of view of an imaging device. The cropping marker may be positionable along a single axis or line, or may be positionable along a plurality of different axes, such as orthogonal axes defined by the optical window. In some embodiments, the cropping marker may be slidable, adhesively connected to the imaging device or imaged object, or may be fastened and/or apposed otherwise to the device and/or object. The cropping marker may be recognized and distinguished (within the image data) according to a predefined optical property, a predefined shape, and/or a predefined set of locations within the field of view. For example, the cropping marker may be positioned adjustably within a predefined perimeter region of the field of view, such as orthogonal strips defined along two edges of the optical window (see FIG. 2). Alternatively, or in addition, the cropping marker may present a distinctive color, shape, pattern, reflectance, symbol, etc., to be imaged.

One or more cropping markers may select a region of the optical window from which cropped image data may be created. Each cropping marker may select a side or a corner of the region, among others. The perimeter of the selected region may have one or more sides and/or corners defined by the border of the optical window. Alternatively, cropping markers may define each side and corner of the selected region. The region selected may have any suitable shape. The region may have a predefined shape, such as rectangular, polygonal, oval, circular, etc.

FIG. 2 shows a top plan view of cropping markers 18 selecting a region 40 within optical window 24 from which cropped image data is created. Region 40 may be selected, for example, to frame a primary image 42, presented by object 40. The primary image faces downward toward the optical window in this view. Cropping markers 18 may include x-indicators 44, 46 and y-indicators 48, 50 disposed adjacent orthogonal edges 52, 54 of optical window 24. X-indicators 44, 46 may be positioned to define the side-to-side (or x-axis) boundaries of selected region 40, and y-indicators 48, 50 may be positioned to define the lengthwise (or y-axis) boundaries of the selected region. Such boundaries may be specified by projection lines 56 extending orthogonally (and conceptually) from edges 52, 54 of the optical window. In some embodiments, one or both of the indicators may be moved to a nonimaged position (or a predefined inert position), so that one or both of the x-axis and/or y-axis boundaries of selected region 40 is defined by one indicator and the perimeter of the optical window or by the optical window alone.

FIG. 3 is a sectional view of a portion imaging device 12 including a cropping marker 18, viewed generally along line 3-3 of FIG. 2. Cropping marker 18 may include a body 60 and a pointer 62 connected to, and extending from, the body. Body 60 may configured to be retained by, and slidable along, a track 64 that is connected to, or defined by, frame 22. Accordingly, the body and pointer 62 may slidably positioned at a plurality of locations along track 64, and thus the perimeter of the optical window (see FIG. 2). Pointer 62 may be configured to extend into the field of view from the perimeter of the optical window, so that the pointer portion of the marker is visible through optical window 24. The body may be disposed outside of the field of view. Cropping marker 18 may be imaged by the image sensor to determine the position of the marker within the field of view of the imaging device, in this case, a position within the optical window. In some embodiments, image capture system 10 may be configured to look for marker data within a portion of the image data that corresponds to a band of the field of view. The band may be disposed at a perimeter of the optical window and/or field of view, for example, lateral to the perimeter of the optical window. The band may have any suitable width, for example, corresponding to one or a plurality of pixels in a corresponding image. Furthermore, the band may provide a portion of the image data that is automatically removed after analysis of marker data.

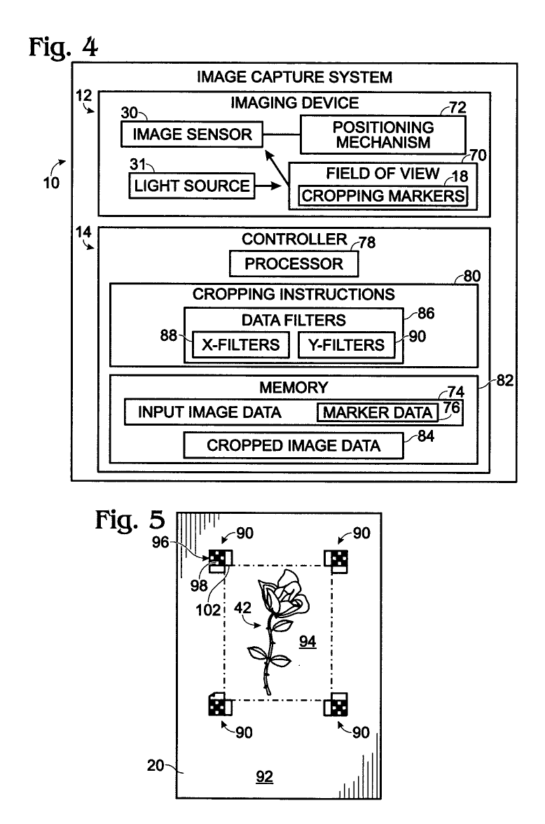

FIG. 4 is a schematic view of selected aspects of image capture system 10. Imaging device 12 of the system may include an image sensor 30 that moves across a field of view 70 using a positioning mechanism 72 to move the image sensor across the field of view, to scan the field of view and acquire the image data. Alternatively, the image sensor may be a two dimensional array that is fixed, and the object may be moved relative to the image sensor, or the image sensor may have a fixed or movable two-dimensional array of sensor elements, among others. Field of view 70 may include one or more cropping markers 18 that are positioned so that the markers are imaged by the image sensor. Light source 31 may be utilized to illuminate the field of view. Accordingly, transmitted or reflected light from the light source, among others, may be sensed by image sensor 30 from the field of view. Input image data 74 may be created by imaging device 12 and may be stored in the imaging device or controller 14, and/or may be modified as it is acquired. Input image data 74 may include marker data 76 contributed by imaged cropping markers 18.

Controller 14 may include a processor 78, cropping instructions 80, and memory 82. Processor 78 may be configured to perform arithmetic and logical operations, among others, on input image data 74. Cropping instructions 80 may be any instructions configured to produce cropped image data 84 from input image data 74 based on marker data 76. Accordingly, cropping instructions 80 may employ processor 78 to analyze input image data 74 to identify marker data 76. Based on aspects of the marker data, such as positions within the input image data, suitable data filters 86, such as an x-filter 88 and a y-filter 90, may be selected to selectively retain, delete, or move, among others, a desired subset of the input image data. The cropped image data may be a subset of the input image data and may include no marker data 76. Memory 82 may be employed to store input image data and cropped image data, and, in some embodiments, cropping instructions 80.

Input image data 74 may be analyzed and cropping may be initiated at any suitable time relative to acquisition of the input image data. In some embodiments, all of the input image data corresponding to one image may be acquired before the marker data is identified and employed to select suitable data filters 86. In some embodiments, only a portion of the input image data may be acquired before at least some of the marker data is identified and employed to select one or more suitable data filters. For example, if input image data is acquired sequentially along the length of the optical window, from top to bottom in FIG. 2, marker data corresponding to cropping x-indicators 44, 46 may be identified and used to select a suitable x-filter 88 before all of the input image data is acquired. Accordingly, the x-filter may cause some of the subsequently acquired input image data to be ignored. Alternatively, the x-filter may select a subset of image sensor elements that are inactivated or from which input data is ignored, so that image sensing is restricted spatially to reduce the field of view.

FIG. 5 shows a plan view of alternative cropping markers 90 disposed on a surface 92 of imaged object 20. Cropping markers 90 may be configured to be imaged by imaging device 12 so that a region 94 within surface 92 of the object is selected for creating cropped image data. This selection also may specify a corresponding region of the optical window of the imaging device that is selected.

Alternative markers 90 may be configured to be connected to object 20. Accordingly, each marker may include an adhesive material configured to temporarily or permanently connect each alternative marker 90 to surface 92 of the object. In exemplary embodiments, alternative markers 90 may be weakly adhesive so that they may be repeatedly re-positioned on a plurality of imaged objects, at any suitable position on the surface, for example, configured as POST-IT® notes. Alternative markers may be configured as thin sheets of materials, such as thin sheets of paper or plastic, to permit surface 92 to abut the optical window of the imaging device. In some embodiments, the alternative markers may be connected to imaged objects (or the optical window or cover) using tape or glue. In some embodiments, the alternative markers may be placed in apposition to the optical window without any connection to the optical window or imaged object.

Each alternative marker 90 may include indicia 96. The indicia may enable marker data to be recognized and distinguished from other input image data. Accordingly, the indicia may include a barcode 98, another symbol, or any other optically distinguishable indicia. Alternatively, or in addition, indicia 96 may include a cropping boundary feature 102. Feature 102 may define one or more edges and/or corners of selected region 94. Accordingly, feature 102 may be a line segment, a dot, an “X”, an “L”, etc. The features may be apposed to a selected boundary or may define boundaries by conceptual projections from the features, as in FIG. 2. Cropping instructions 80 may be configured so that the perimeter of selected region 94 is spaced by a predefined amount from alternative markers 90, so that these markers are not visible in a resultant cropped image.

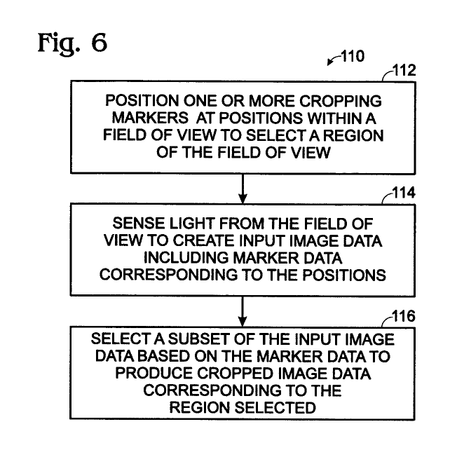

FIG. 6 is a flowchart of a method 110 of capturing cropped optical images in digital form, in accordance with an embodiment of the invention. One or more cropping markers may be positioned at positions within a field of view to select a region of the field of view, shown at 112. Light may be sensed from the field of view to create input image data including marker data corresponding to the positions, shown at 114. A subset of the input image data may be selected based on the marker data to produce cropped image data corresponding to the region selected, shown at 116.

It is believed that the disclosure set forth above encompasses multiple distinct embodiments of the invention. While each of these embodiments has been disclosed in specific form, the specific embodiments thereof as disclosed and illustrated herein are not to be considered in a limiting sense as numerous variations are possible. The subject matter of this disclosure thus includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

1. A device for capturing cropped images in digital form, comprising:
an optical window;
an image sensor configured to sense optical information received at least substantially through the optical window so that input image data is created; and
one or more cropping markers adjustably positionable adjacent the optical window so that the cropping markers are imaged by the image sensor to contribute marker data to the input image data,
wherein a controller is configured to create cropped image data from a subset of the input image data according to the marker data.

2. The device of claim 1, wherein the controller is configured to analyze the input image data to define positions of the marker data within the input image data and to create the cropped image data according to the positions.

3. The device of claim 1, wherein the image sensor defines a field of view from which the input image data is acquired, the field of view including a region lateral to the optical window, and wherein at least one of the cropping markers is configured to be disposed within the region.

4. The device of claim 1, wherein the image sensor is configured to scan across the optical window to sense subsets of the optical information sequentially.

5. The device of claim 1, further comprising a frame that defines the optical window, wherein the cropping markers are connected slidably to the frame.

6. The device of claim 5, wherein the optical window defines orthogonal axes, and wherein the device includes a pair of cropping markers for each orthogonal axis.

7. The device of claim 1, wherein the optical window defines a plane, and wherein each of the cropping markers is configured to be apposed to the optical window at a position adjustable along a plurality of axes disposed parallel to the plane.

8. The device of claim 7, wherein the optical window is configured to abut a sheet of material that contributes to the optical information, and wherein the cropping markers are configured to be disposed between the sheet and the optical window.

9. The device of claim 8, wherein the cropping markers are configured to be connected adhesively to the sheet of material.

10. The device of claim 1, wherein the cropping markers are configured so that the controller can identify the marker data by position.

11. The device of claim 1, where the cropping markers include optically detectable indicia, and wherein the cropping markers are configured so that the controller can identify the marker data according to the indicia.

12. The device of claim 1, wherein the controller is configured to at least one of remove, ignore, and move portions of the input image data to create the cropped image data.

13. The device of claim 1, wherein the controller is configured to restrict sensing of input image data by the image sensor based on the marker data.

14. A device for capturing cropped images in digital form, comprising:
an optical window defining orthogonal axes;
an image sensor configured to sense optical information received at least substantially through the optical window so that input image data is acquired; and
a pair of cropping markers for each of the axes, each pair being configured to slide along a respective orthogonal axis to selected physical positions adjacent the optical window so that the cropping markers are imaged by the image sensor to contribute marker data to the input image data,
wherein a controller is configured to analyze the input image data to define data positions of the marker data within the input image data and to create cropped image data from a subset of the input image data according to the data positions.

15. A method of capturing cropped images in digital form, comprising:
positioning one or more cropping markers at positions within a field of view to select a region of the field of view;
sensing light from the field of view to create input image data including marker data corresponding to the positions; and
selecting a subset of the input image data based on the marker data to produce cropped image data corresponding to the region selected.

16. The method of claim 15, wherein positioning includes sliding a pair of cropping markers to selected positions along a line.

17. The method of claim 15, wherein positioning includes selecting a position for a cropping marker along at least two nonparallel axes.

18. The method of claim 15, wherein the input image data is provided at least in part by a sheet of material placed in the sensed area, and wherein positioning includes placing a cropping marker in apposition to the sheet of material.

19. The method of claim 15, wherein selecting a subset of the input image data includes removing a portion of the input image data that does not correspond to the region selected.

20. The method of claim 15, which further comprises restricting sensing light from the field of view based on the marker data.

21. A program storage device readable by a processor, tangibly embodying a program of instructions executable by the processor to perform a method of capturing cropped images in digital form, the method comprising:
positioning one or more cropping markers at positions within a field of view to select a region of the field of view;
sensing light from the field of view to create input image data including marker data corresponding to the positions; and
selecting a subset of the input image data based on the marker data to produce cropped image data corresponding to the region selected.
